(19) United States
(12) Patent Application Publication
(10) Pub. No.: US 2024/0247466 A1
(43) Pub. Date: Jul. 25, 2024

(54) WORK MACHINE AND METHOD FOR CONTROLLING WORK MACHINE

(71) Applicant: KOMATSU LTD., Tokyo (JP)

(72) Inventors: Takuya SONODA, Tokyo (JP); Takashi MAEDA, Tokyo (JP); Yoshihide NAKAE, Tokyo (JP)

(21) Appl. No.: 18/560,484

(22) PCT Filed: Jun. 15, 2022
(86) PCT No.: PCT/JP2022/023958

§ 371 Date: Nov. 13, 2023

(30) Foreign Application Priority Data
Aug. 20, 2021 (JP) 2021-134905

(51) Int. Cl. E02F 9/22; E02F 9/08

(52) U.S. Cl. CPC E02F 9/225; E02F 9/0841; E02F 9/2203; E02F 9/2285; E02F 9/2292

(57) ABSTRACT

A work machine includes a vehicle body, a steering control wheel, an actuator, and a controller. The vehicle body includes a rear frame and a front frame coupled to the rear frame so as to turn with respect to the rear frame. The steering control wheel is supported by the front frame. The actuator changes a steering angle of the steering control wheel. The controller controls the actuator. The controller determines a target direction in which the vehicle body travels, acquires an articulate angle of the front frame with respect to the rear frame, and sets the steering angle so that the vehicle body moves in the target direction by controlling the actuator in accordance with the articulate angle.

### CROSS-REFERENCE TO RELATED APPLICATIONS

This application is a U.S. National stage application of International Application No. PCT/JP2022/023958, filed on Jun. 15, 2022. This U.S. National stage application claims priority under 35 U.S.C. § 119(a) to Japanese Patent Application No. 2021-134905, filed in Japan on Aug. 20, 2021, the entire contents of which are hereby incorporated herein by reference.

### BACKGROUND

### Technical Field

The present invention relates to a work machine and a method for controlling the work machine.

### Background Information

A conventional work machine has a rear frame, a front frame that turns with respect to the rear frame, and steering control wheels supported by the front frame. In this type of work machine, the traveling direction of the work machine is determined by changing the turning of the front frame with respect to the rear frame and the steering angle of the steering control wheels.

A work machine may easily deviate from a target route during traveling due to a load caused by earth and sand or due to an uneven road surface. As a result, the operator is required to operate a steering member for maintaining the route while operating the work implement such as a blade at the same time. Such type of operation is difficult and the operating load on the operator is large.

Accordingly, Japanese Patent Laid-open No. 2021-054269 discloses an automatic steering control for automatically controlling a steering angle so that the work machine maintains the traveling direction in the target direction.

### SUMMARY

In the abovementioned conventional work machine, the work machine proceeds in the target direction due to the automatic steering control. For example, in the conventional work machine, the automatic steering control is executed when the articulate angle that is the turning angle of the front frame with respect to the rear frame is zero. In this case, the controller determines whether the work machine is proceeding in the target direction during the execution of the automatic steering control. When the traveling direction of the work machine deviates from the target direction, the controller causes the work machine to proceed in the target direction by controlling the steering angle.

An object of the present invention is to provide a work machine with which it is possible to move in the target direction even if the articulate angle has changed.

A work machine according to one aspect of the present invention comprises a vehicle body, a steering control wheel, an actuator, and a controller. The vehicle body includes a rear frame and a front frame coupled to the rear frame so as to turn with respect to the rear frame. The steering control wheel is supported by the front frame. The actuator changes a steering angle of the steering control wheel. The controller controls the actuator.

The controller determines a target direction in which the vehicle body travels. The controller acquires an articulate angle of the front frame with respect to the rear frame. The controller sets the steering angle so that the vehicle body moves in the target direction by controlling the actuator in accordance with the articulate angle.

A method according to another aspect of the present invention is a method for controlling a work machine. The work machine includes a vehicle body, a steering control wheel, and an actuator. The vehicle body includes a rear frame and a front frame coupled to the rear frame so as to turn with respect to the rear frame. The steering control wheel is supported by the front frame.

The method according to the present aspect comprises determining a target direction in which the vehicle body travels, acquiring an articulate angle of the front frame with respect to the rear frame, and setting a steering angle so that the vehicle body moves in the target direction by controlling the actuator in accordance with the articulate angle.

According to the present invention, the actuator is controlled in accordance with the articulate angle in a state in which the target direction of the vehicle body is acquired. The steering angle is set so that the vehicle body moves in the target direction due to the control of the actuator. As a result, the work machine is able to move in the target direction even if the articulate angle has changed.

### BRIEF DESCRIPTION OF DRAWINGS

FIG. 1 is a perspective view of a work machine according to an embodiment.

FIG. 2 is a side view of the work machine.

FIG. 3 is a schematic view of a configuration of the work machine.

FIG. 4A is a top view of a front part of the work machine.

FIG. 4B is a top view of the front part of the work machine.

FIG. 5 is a flow chart illustrating a process for setting a steering angle in accordance with an articulate angle during automatic control.

FIG. 6A is a top view of the front part of the work machine.

FIG. 6B is a top view of the front part of the work machine.

### DETAILED DESCRIPTION OF EMBODIMENT(S)

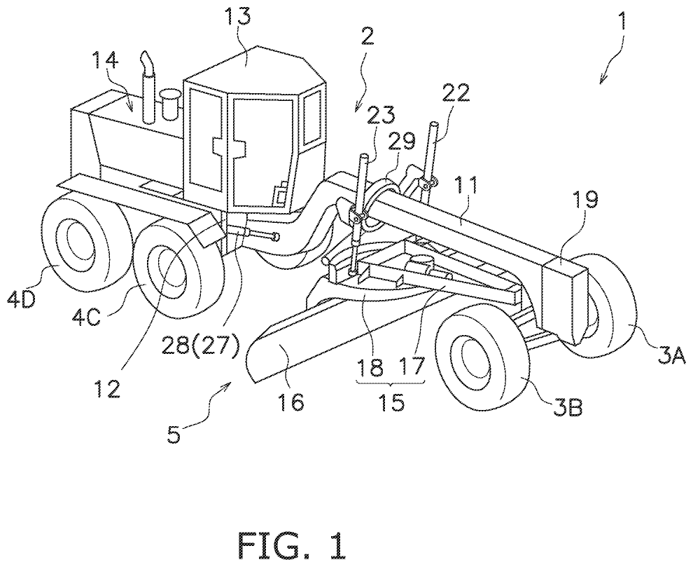

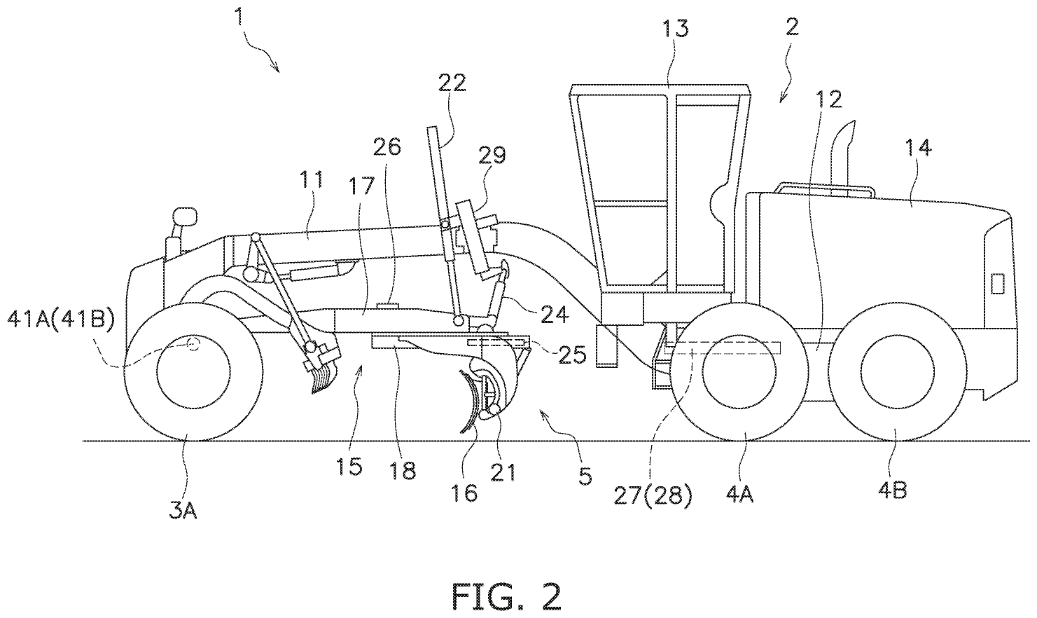

An embodiment of the present invention will be described below with reference to the drawings. FIG. 1 is a perspective view of a work machine 1 according to the embodiment. FIG. 2 is a side view of the work machine 1. As illustrated in FIG. 1, the work machine 1 includes a vehicle body 2, front wheels 3A and 3B, rear wheels 4A to 4D, and a work implement 5. The vehicle body 2 includes a front frame 11, a rear frame, 12, a cab 13, and a power chamber 14.

The rear frame 12 is connected to the front frame 11. The front frame 11 is coupled to the rear frame 12 so as to allow turning with respect to the rear frame 12. For example, the front frame 11 is able to articulate to the left and right with respect to the rear frame 12.

In the following explanation, the front, rear, left, and right directions signify the front, rear, left, and right directions of the vehicle body 2 while the articulate angle is zero, that is while the front frame 11 and the rear frame 12 are straight.

The cab 12 and the power chamber 14 are disposed on the rear frame 12. An unillustrated operator's seat is disposed in the cab 13. The cab 13 is disposed behind the power chamber 14. The front frame 11 extends forward from the rear frame 12. The front wheels 3A and 3B are attached to the front frame 11. The front wheels 3A and 3B are disposed away from each other in the left-right direction. The front wheels 3A and 3B are rotatably supported by the front frame 11. The rear wheels 4A to 4D are attached to the rear frame 12.

The work implement 5 is movably connected to the vehicle body 2. The work implement 5 includes a supporting member 15 and a blade 16. The supporting member 15 is movably connected to the vehicle body 2. The supporting member 15 supports the blade 16. The supporting member 15 includes a drawbar 17 and a circle 18. The drawbar 17 is disposed below the front frame 11.

The drawbar 17 is connected to a front part 19 of the front frame 11. The drawbar 17 extends rearward from the front part 19 of the front frame 11. The drawbar 17 is swingably supported at least in the up-down direction and the left-right direction of the vehicle body 2 with respect to the front frame 11. For example, the front part 19 includes a ball joint. The drawbar 17 is rotatably connected to the front frame 11 via the ball joint.

The circle 18 is connected to a rear part of the drawbar 17. The circle 18 is rotatably supported with respect to the drawbar 17. The blade 16 is connected to the circle 18. The blade 16 is supported by the drawbar 17 via the circle 18. As illustrated in FIG. 2, the blade 16 is supported by the circle 18 so as to be able to rotate about a tilt shaft 21. The tilt shaft 21 extends in the left-right direction.

As illustrated in FIG. 2, the work machine 1 includes a plurality of steering actuators 41A and 41B, and a plurality of articulating actuators 27 and 28.

The plurality of steering actuators 41A and 41B are used for steering the front wheels 3A and 3B. For example, the plurality of steering actuators 41A and 41B are hydraulic cylinders. The plurality of steering actuators 41A and 41B are respectively connected to the front wheels 3A and 3B. The plurality of steering actuators 41A and 41B extend and contract due to hydraulic pressure. In the following explanation, the extension and contraction of the plurality of steering actuators 41A and 41B and the extension and contraction of, for example, the hydraulic cylinders are referred to as “stroke motions.”

The plurality of steering actuators 41A and 41B include the left steering actuator 41A and the right steering actuator 41B. The left steering actuator 41A and the right steering actuator 41B are disposed away from each other in the left-right direction.

The left steering actuator 41A is connected to the front frame 11 and the front wheel 3A. The right steering actuator 41B is connected to the front frame 11 and the front wheel 3B. The front wheels 3A and 3B are steered by the stroke motions of the left steering actuator 41A and the right steering actuator 41B.

The left steering actuator 41A is illustrated in FIG. 2 and the right steering actuator 41B is not illustrated. The left steering actuator 41A and the right steering actuator 41B are counterpart members and therefore the reference symbols of members that are not illustrated in FIG. 2 are depicted in parentheses.

The plurality of articulating actuators 27 and 28 are used for turning the front frame 11 with respect to the rear frame 12. For example, the plurality of articulating actuators 27 and 28 are hydraulic cylinders. The plurality of articulating actuators 27 and 28 are connected to the front frame 11 and the rear frame 12. The plurality of articulating actuators 27 and 28 extend and contract due to hydraulic pressure.

The plurality of articulating actuators 27 and 28 include the left articulate cylinder 27 and the right articulate cylinder 28. The left articulate cylinder 27 and the right articulate cylinder 28 are disposed away from each other in the left-right direction.

The left articulate cylinder 27 is connected to the front frame 11 and the rear frame 12 on the left side of the vehicle body 2. The right articulate cylinder 28 is connected to the front frame 11 and the rear frame 12 on the right side of the vehicle body 2. The front frame 11 turns to the left or right with respect to the rear frame 12 due to the stroke motions of the left articulate cylinder 27 and the right articulate cylinder 28.

The right articulate cylinder 28 is illustrated in FIG. 1 and the left articulate cylinder 27 is not illustrated. The left articulate cylinder 27 is illustrated in FIG. 2 and the right articulate cylinder 28 is not illustrated. The left articulate cylinder 27 and the right articulate cylinder 28 are counterpart members and therefore the reference symbols of members that are not illustrated in FIG. 1 and FIG. 2 are depicted in parentheses.

As illustrated in FIG. 2, the work machine 1 includes a plurality of actuators 22 to 26 for changing the orientation of the work implement 5. The plurality of actuators 22 to 25 are, for example, hydraulic cylinders. The actuator 26 is a rotation actuator. In the present embodiment, the rotation actuator 26 is a hydraulic motor. The rotation actuator 26 may be an electric motor.

The plurality of actuators 22 to 25 are connected to the work implement 5. The plurality of actuators 22 to 25 extend and contract due to hydraulic pressure. The plurality of hydraulic cylinders 22 to 25 change the orientation of the work implement 5 with respect to the vehicle body 2 by extending and contracting.

Specifically, the plurality of hydraulic cylinders 22 to 25 include a left lift cylinder 22, a right lift cylinder 23, a drawbar shift cylinder 24, and a blade tilt cylinder 25.

The left lift cylinder 22 and the right lift cylinder 23 are disposed away from each other in the left-right direction. The left lift cylinder 22 and the right lift cylinder 23 are connected to the drawbar 17. The left lift cylinder 22 and the right lift cylinder 23 are connected to the front frame 11 via a lifter bracket 29. The drawbar 17 swings up and down due to the stroke motions of the left lift cylinder 22 and the right lift cylinder 23. As a result, the blade 16 moves up and down.

The drawbar shift cylinder 24 is coupled to the drawbar 17 and the front frame 11. The drawbar shift cylinder 24 is connected to the front frame 11 via the lifter bracket 29. The drawbar shift cylinder 24 extends diagonally downward from the front frame 11 toward the drawbar 17. The drawbar 17 swings left and right due to the stroke motions of the drawbar shift cylinder 24.

The blade tilt cylinder 25 is connected to the circle 18 and the blade 16. The blade 16 rotates about the tilt shaft 21 due to the stroke motions of the blade tilt cylinder 25.

The actuator 26 is connected to the drawbar 17 and the circle 18. The actuator 26 causes the circle 18 to rotate with respect to the drawbar 17. Consequently, the blade 16 rotates about a rotation axis that extends in the up-down direction.

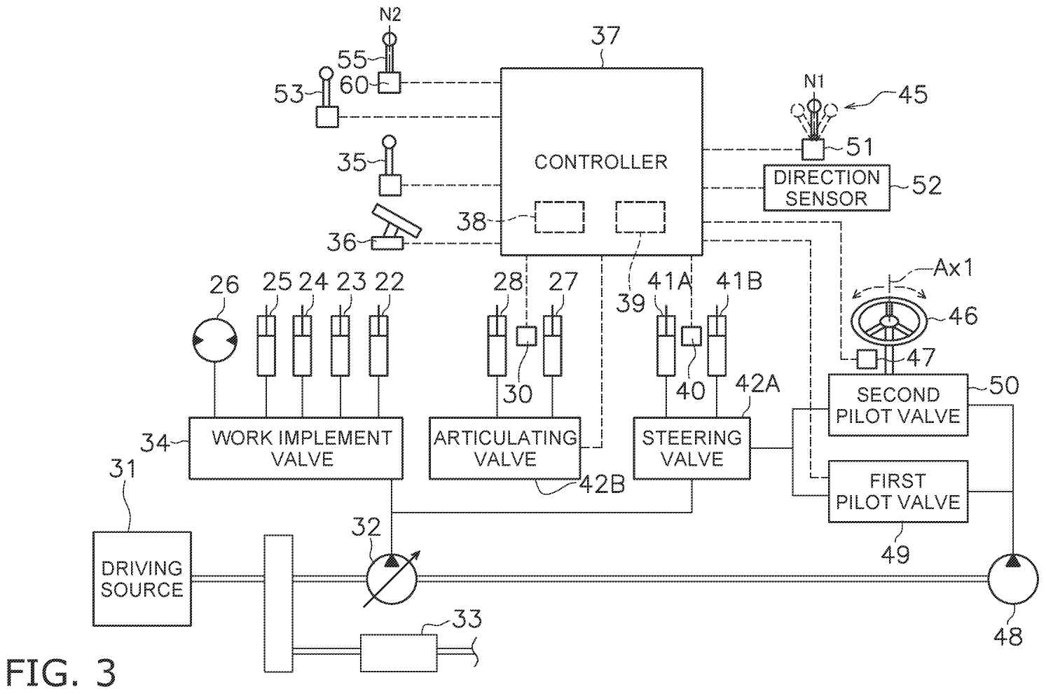

FIG. 3 is a schematic view illustrating a configuration of the work machine 1. The work machine 1 includes a driving source 31, a first hydraulic pump 32, a second hydraulic pump 48, a first pilot valve 49, and a second pilot valve 50. The work machine 1 includes a steering valve 42A, an articulating valve 42B, and a work implement valve 34. The work machine 1 includes a power transmission device 33.

The driving source 31 is, for example, an internal combustion engine. Alternatively, the driving source 31 may be an electric motor or a hybrid of an internal combustion engine and an electric motor.

The first hydraulic pump 32 is driven by the driving source 31 thereby discharging hydraulic fluid. The first hydraulic pump 32 supplies hydraulic fluid to the steering valve 42A, the articulating valve 42B, and the work implement valve 34. The plurality of steering actuators 41A and 41B, the plurality of articulating actuators 27 and 28, and the plurality of actuators 22 to 26 operate due to the hydraulic fluid supplied through the aforementioned valves.

The second hydraulic pump 48 is driven by the driving source 31 thereby discharging hydraulic fluid. The first pilot valve 49 is connected through a hydraulic circuit to the second hydraulic pump 48 and the steering valve 42A. The first pilot valve 49 controls the pressure of the hydraulic fluid supplied from the second hydraulic pump 48 to the pilot port of the steering valve 42A. The first pilot valve 49 is an electromagnetic proportional control valve.

The second pilot valve 50 is connected through the hydraulic circuit to the second hydraulic pump 48 and the below mentioned steering valve 42A. The second pilot valve 50 is connected to a second steering member 46. The second pilot valve 50 controls the pressure (referred to below as “pilot hydraulic pressure”) of the hydraulic fluid supplied from the second hydraulic pump 48 to the pilot port of the steering valve 42A in response to the operation of the second steering member 46. The second pilot valve 50 may be an electromagnetic proportional control valve in the same way as the first pilot valve 49.

The steering valve 42A is connected through the hydraulic circuit to the first hydraulic pump 32 and the plurality of steering actuators 41A and 41B. The steering valve 42A controls the flow rate of hydraulic fluid supplied from the first hydraulic pump 32 to the plurality of steering actuators 41A and 41B. The steering valve 42A is, for example, a hydraulic pilot type of control valve. The plurality of steering actuators 41A and 41B perform stroke motions due to the hydraulic fluid from the first hydraulic pump 32 being supplied to the steering valve 42A.

The articulating valve 42B is connected to the first hydraulic pump 32 and the plurality of articulating actuators 27 and 28 through the hydraulic circuit. The articulating valve 42B controls the flow rate of the hydraulic fluid supplied from the first hydraulic pump 32 to the plurality of articulating actuators 27 and 28. For example, the articulating valve 42B is, for example, a hydraulic pilot type of control valve. The plurality of articulating actuators 27 and 28 perform stroke motions due to the hydraulic fluid from the first hydraulic pump 32 being supplied to the articulating valve 42B.

The work implement valve 34 is connected to the first hydraulic pump 32 and the plurality of actuators 22 to 26 via the hydraulic circuit. The work implement valve 34 includes a plurality of valves respectively connected to the plurality of actuators 22 to 26. The work implement valve 34 controls the flow rate of hydraulic fluid supplied from the first hydraulic pump 32 to the plurality of actuators 22 to 26. The work implement valve 34 is, for example, an electromagnetic proportional control valve. Alternatively, the work implement valve 34 may be a hydraulic pilot-type proportional control valve.

The power transmission device 33 transmits the driving power from the driving source 31 to the rear wheels 4A to 4D. The power transmission device 33 may include a torque converter and/or a plurality of speed change gears. Alternatively, the power transmission device 33 may be transmission of another type such as a hydraulic static transmission (HST) or a hydraulic mechanical transmission (HMT).

As illustrated in FIG. 3, the work machine 1 includes a first steering member 45, the second steering member 46, an articulating lever 55, a work implement operating member 35, a shift member 53, and an accelerator operating member 36.

The first steering member 45 and the second steering member 46 are operable by an operator for steering the front wheels 3A and 3B. The first steering member 45 is a lever such as a joy stick. Alternatively, the first steering member 45 may be a member other than a lever.

The first steering member 45 is configured to be tilted to the left or right from a neutral position N1. The first steering member 45 is connected to a first operation sensor 51. The first operation sensor 51 is included in the work machine 1. The first operation sensor 51 outputs a first operation signal that indicates an operation on the first steering member 45 by the operator. For example, the first operation sensor 51 detects the tilt angle of the first steering member 45 and outputs the first operation signal corresponding to the tilt angle of the first steering member 45.

The second steering member 46 is a steering wheel. Alternatively, the second steering member 46 may be a member other than a steering wheel. The second steering member 46 is held in the lastly operated position when not operated by the operator. When the first steering member 45 and the second steering member 46 are operated at the same time, the operation of the second steering member 46 is prioritized.

The second steering member 46 is rotatable about a rotation axis Ax1. A second operation sensor 47 is attached to the second steering member 46. The second operation sensor 47 is included in the work machine 1. The second operation sensor 47 outputs a second operation signal that indicates an operation on the second steering member 46 by the operator. For example, the second operation sensor 47 detects the angular displacement about the rotation axis Ax1 of the second steering member 46 and outputs the second operation signal corresponding to the angular displacement of the second steering member 46.

The articulating lever 55 is operable by the operator for turning the front frame 11 with respect to the rear frame 12. The articulating lever 55 is a lever such as a joystick. Alternatively, the articulating lever 55 may be a member other than a lever.

The articulating lever 55 is configured to be tilted to the left or right from a neutral position N2. The articulating lever 55 is connected to a third operation sensor 60. The third operation sensor 60 is included in the work machine 1. The third operation sensor 60 outputs a third operation signal that indicates an operation on the articulating lever 55 by the operator. For example, the third operation sensor 60 detects the operating amount of the articulating lever and outputs the third operation signal corresponding to the operating amount of the articulating lever.

The work implement operating member 35 is operable by the operator in order to change the orientation of the work implement 5. The work implement operating member 35 includes, for example, a plurality of operating levers. Alternatively, the work implement operating member 35 may be another member such as a switch or a touch screen. The work implement operating member 35 outputs signals indicating the operations of the work implement operating member 35 by the operator.

The shift member 53 is operable by the operator for switching between forward travel and reverse travel of the work machine 1. The shift member 53 includes, for example, a shift lever. Alternatively, the shift member 53 may be another member such as a switch or a touch screen. The shift member 53 outputs signals indicating the operations of the shift member 53 by the operator.

The accelerator operating member 36 is operable by an operator for controlling the travel of the work machine 1. The accelerator operating member 36 includes, for example, an accelerator pedal. Alternatively, the accelerator operating member 36 may be another member such as a switch or a touch screen. The accelerator operating member 36 outputs signals indicating the operations of the accelerator operating member 36 by the operator.

The work machine 1 includes a direction sensor 52, a steering angle sensor 40, and an articulate angle sensor 30. The direction sensor 52 detects the traveling direction of the vehicle body 2. The direction sensor 52 outputs direction signals indicating the traveling direction of the vehicle body 2. The direction sensor 52 is, for example, an inertial measurement device (IMU). Alternatively, the direction sensor 52 may be a global navigation satellite system (GNSS) receiver such as a global positioning system (GPS) device.

The steering angle sensor 40 is used for detecting a steering angle θ1 of the front wheels 3A and 3B. The steering angle sensor 40 detects, for example, the stroke amounts of the plurality of steering actuators 41A and 41B. The steering angle sensor 40 outputs a stroke signal that indicates the stroke amounts. The steering angle sensor 40 may directly detect the steering angle θ1. In this case, the steering angle sensor 40 outputs an angle signal indicating the steering angle θ1.

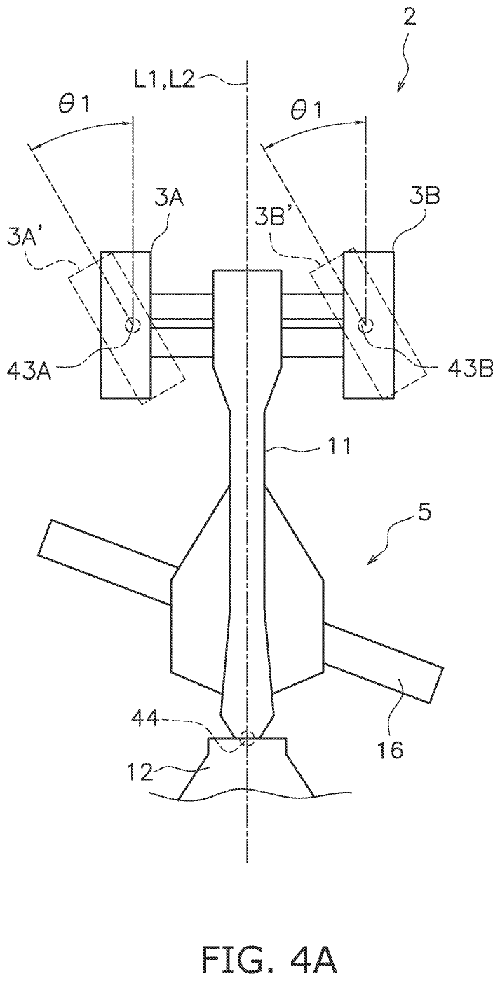

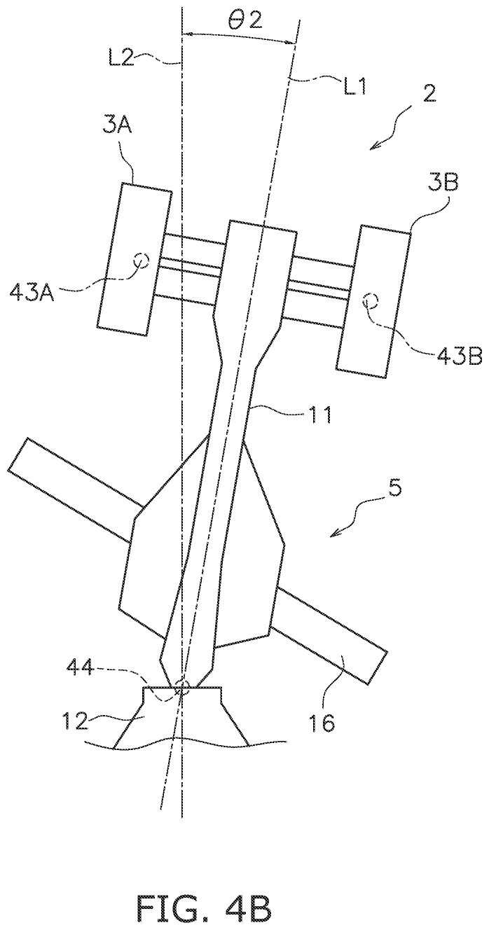

The steering angle θ1 is defined as described below. As illustrated in FIG. 4A, the work machine 1 includes a first steering shaft 43A and a second steering shaft 43B. The first steering shaft 43A and the second steering shaft 43B are the turning shafts of the front wheels 3A and 3B respectively.

The first steering shaft 43A and the second steering shaft 43B are provided to the front frame 11. The first steering shaft 43A and the second steering shaft 43B extend in the up-down direction. The first steering shaft 43A and the second steering shaft 43B turnably support the front wheels 3A and 3B respectively.

The steering angle θ1 is the angle that the front wheels 3A and 3B turn with respect to the front frame 11 about the first steering shaft 43A and the second steering shaft 43B respectively. For example, the steering angle θ1 is the turning angle of the front wheels 3A and 3B with respect to the front-back direction of the front frame 11.

Specifically, a first center line L1 is defined on the front frame 11. The first center line L1 is the center line of the front frame 11 that extends in the front-back direction of the front frame 11. The first center line L1 passes through a below mentioned articulate shaft 44 as seen in a top view of the work machine 1. The steering angle θ1 is the turning angle of the front wheels 3A and 3B in reference to the first center line L1.

The steering angle θ1 changes from a neutral position to the left or right due to the stroke motions of the plurality of steering actuators 41A and 41B. The steering angle θ1 at the neutral position is zero degrees. The front wheels 3A and 3B are disposed parallel to the first center line L1 of the front frame 11 at the neutral position. In FIG. 4A, 3A′ and 3B′ represent the front wheels while turned by the steering angle θ1 from the neutral position.

The articulate angle sensor 30 is used to detect an articulate angle θ2 of the front frame 11 with respect to the rear frame 12. The articulate angle sensor 30 detects the stroke amounts of the left articulate cylinder 27 and the right articulate cylinder 28. The articulate angle sensor 30 outputs a stroke signal that indicates the stroke amounts. The articulate angle sensor 30 may detect the articulate angle θ2 directly. In this case, the articulate angle sensor 30 outputs an angle signal that indicates the articulate angle θ2.

The articulate angle θ2 is defined as described below. As illustrated in FIG. 4B, the work machine 1 includes the articulate shaft 44. The articulate shaft 44 is connected to the front frame 11 and the rear frame 12. The articulate shaft 44 extends in the up-down direction. The articulate shaft 44 turnably supports the front frame 11.

The articulate angle θ2 is the angle that the front frame 11 turns with respect to the rear frame 12 about the articulate shaft 44. For example, a second center line L2 is defined on the rear frame 12. The second center line L2 is the center line of the rear frame 12 that extends in the front-back direction of the rear frame 12. The second center line L2 passes through the articulate shaft 44 as seen in a top view of the work machine 1.

The articulate angle θ2 is the angle formed by the first center line L1 and the second center line L2. When the articulate angle θ2 is zero, the direction of the second center line L2 matches the direction of the first center line L1 as illustrated in FIG. 4A. FIG. 4B illustrates a state in which the first center line L1 is turned by the articulate angle θ2 with respect to the second center line L2 with reference to the articulate shaft 44.

As illustrated in FIG. 3, the work machine 1 includes a controller 37. The controller 37 includes a storage device 38 and a processor 39. The processor 39 is, for example, a CPU and executes a program for controlling the work machine 1. The storage device 38 includes a memory such as a RAM or a ROM, and an auxiliary storage device such as an SSD or an HDD. The storage device 38 stores programs and data for controlling the work machine 1.

The controller 37 acquires the operating amount of the first steering member 45 from the first operation signal from the first operation sensor 51. The controller 37 acquires the operating amount of the second steering member 46 from the second operation signal from the second operation sensor 47. The controller 37 prioritizes the second operation signal when the first operation signal and the second operation signal are acquired at the same time.

When the first steering member 45 is operated, the controller 37 controls the pilot hydraulic pressure to the steering valve 42A by controlling the first pilot valve 49 in accordance with the first operation signal. Consequently, the hydraulic fluid supplied from the steering valve 42A to the plurality of steering actuators 41A and 41B is controlled and the plurality of steering actuators 41A and 41B extend and contract. As a result, the steering angle θ1 of the front wheels 3A and 3B is changed.

When the second steering member 46 is operated, the pilot hydraulic pressure from the second pilot valve 50 to the steering valve 42A is controlled in accordance with the operation of the second steering member 46. Consequently, the hydraulic fluid supplied from the steering valve 42A to the plurality of steering actuators 41A and 41B is controlled and the plurality of steering actuators 41A and 41B extend and contract. As a result, the steering angle θ1 of the front wheels 3A and 3B is changed. The controller 37 may adjust the pilot pressure output to the steering valve 42A by controlling the first pilot valve 49 in accordance with the second operation signal. Consequently, the steering angle θ1 of the front wheels 3A and 3B may be changed. In this case, the second pilot valve 50 may be omitted.

The controller 37 acquires the operating amount of the articulating lever 55 from the third operation signal from the articulating lever 55. The controller 37 controls the articulating valve 42B. For example, the controller 37 controls the articulating valve 42B in accordance with the third operation signal thereby causing the left articulate cylinder 27 and the right articulate cylinder 28 to extend and contract. As a result, the controller 37 changes the articulate angle θ2.

The controller 37 controls the power transmission device 33 in response to an operation of the shift member 53. As a result, the traveling direction of the work machine 1 switches between forward travel and reverse travel. Alternatively, the shift member 53 may be mechanically connected to the power transmission device 33. The action of the shift member 53 may be mechanically transmitted to the power transmission device 33 whereby the gears for forward travel and reverse travel of the power transmission device 33 may be switched.

The controller 37 controls the driving source 31 and the power transmission device 33 in response to an operation on the accelerator operating member 36. As a result, the work machine 1 is able to travel. The controller 37 controls the first hydraulic pump 32 and the work implement valve 34 in response to an operation on the work implement operating member 35. Consequently, the work implement 5 is operated.

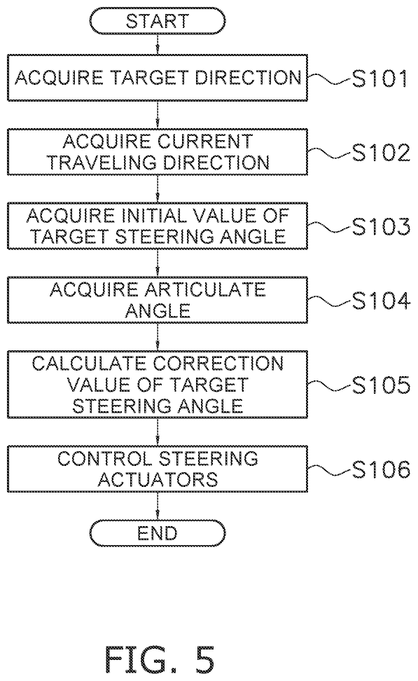

Next, the automatic steering control executed by the controller 37 will be explained. In the automatic steering control, the controller 37 controls the steering angle θ1 in accordance with the articulate angle θ2 so as to hold the traveling direction of the work machine 1 in a target direction. FIG. 5 is a flow chart illustrating a process of the automatic steering control.

In step S101, the controller 37 acquires the target direction. For example, the controller 37 determines the traveling direction of the vehicle body 2 as the target direction after the work machine 1 has turned due to an operation of the first steering member 45. Alternatively, the controller 37 may determine the target direction so that the work machine 1 moves along a previously set target route. For example, the target route may be input by the operator into the controller 37. The target route may be input from an external computer into the controller 37. Alternatively, the controller 37 may automatically generate the target route.

In step S102, the controller 37 acquires the current traveling direction of the vehicle body 2. The controller 37 acquires the current traveling direction of the vehicle body 2 from the direction signal from the direction sensor 52.

In step S103, the controller 37 acquires an initial value of a target steering angle. The initial value of the target steering angle is the target steering angle when the articulate angle θ2 is zero. The controller 37 determines the initial value of the target steering angle so that the current traveling direction of the work machine 1 matches the target direction. For example, the controller 37 determines a value obtained by multiplying the difference between the current traveling direction and the target direction by a predetermined gain, as the initial value of the target steering angle. The controller 37 may reduce the gain as the vehicle speed increases.

In step S104, the controller 40 acquires the actual articulate angle θ2. The controller 37 acquires the articulate angle θ2 with the angle signal from the articulate angle sensor 30.

In step S105, the controller 37 calculates a correction value of the target steering angle. The controller 37 calculates the correction value of the target steering angle by correcting the initial value of the target steering angle in accordance with the articulate angle θ2. For example, the controller 37 calculates the correction value of the target steering angle using the following equation (1).

A1=A0−θ2 (1)

A1 is the correction value of the target steering angle. A0 is the initial value of the target steering angle. In equation (1), the positive and minus values of each value of the correction value and the initial value of the target steering angle and the articulate angle are the same so long as the rotating direction is the same. For example, the correction value and the initial value of the target steering angle and the articulate angle may set the angle from the neutral position to the left as positive values and may set the angle to the right as negative values. Alternatively, the correction value and the initial value of the target steering angle and the articulate angle may set the angle from the neutral position to the left as negative values and may set the angle to the right as positive values.

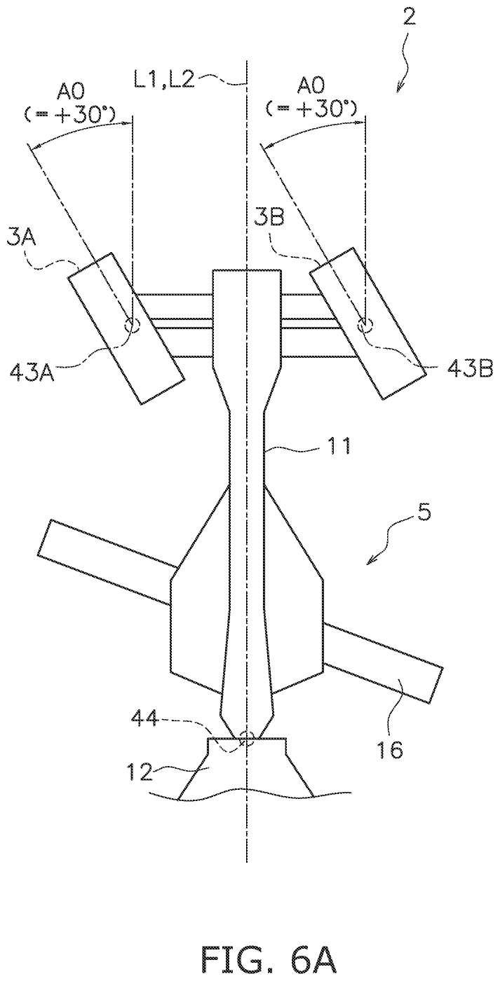

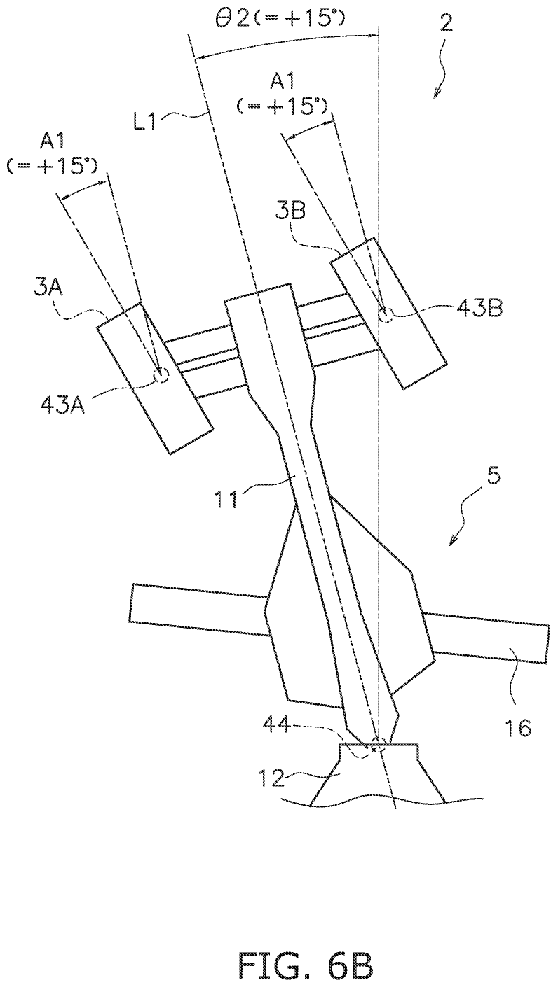

For example, as illustrated in FIG. 6A, when the articulate angle θ2 is zero degrees, the initial value A0 of the target steering angle is +30 degrees. In this case, as illustrated in FIG. 6B, when the articulate angle θ2 is +15 degrees, the correction value A1 of the target steering angle is +15 degrees. The above numerical values are merely examples for ease of understanding and the scope of the present invention is not limited thereto.

In step S106, the controller 37 controls the steering actuators 41A and 41B so that the actual steering angle θ1 becomes the target steering angle. When the articulate angle θ2 is zero, the target steering angle is the initial value A0. When the articulate angle θ2 is less than zero or greater than zero, the target steering angle is the correction value A1.

During the automatic steering control, the controller 37 repeatedly executes the above processing. Consequently, the steering angle θ1 is automatically controlled so that the work machine 1 travels in the target direction.

In the work machine 1 according to the present embodiment discussed above, the controller 37 determines the target direction in which the vehicle body 2 travels. The controller 37 acquires an articulate angle θ2 of the front frame 1 with respect to the rear frame 12. The controller 37 controls the plurality of steering actuators 41A and 41B in accordance with the articulate angle θ2. As a result, the steering angle θ1 is set so that the vehicle body 2 moves in the target direction.

Due to the configuration of the work machine 1 in this way, the plurality of steering actuators 41A and 41B are controlled in accordance with the articulate angle θ2 while the target direction of the vehicle body 2 is acquired. Due to the control of the plurality of steering actuators 41A and 41B, the steering angle θ1 is set so that the vehicle body 2 moves in the target direction. As a result, the work machine 1 is able to move in the target direction even if the articulate angle θ2 has changed.

Although an embodiment of the present invention has been described so far, the present invention is not limited to the above embodiment and various modifications may be made within the scope of the invention.

The process for controlling the plurality of steering actuators 41A and 41B in accordance with the current articulate angle θ2 may be applied even when the vehicle body 2 is traveling in reverse and not only when the vehicle body 2 is traveling forward as in the above embodiment. In this case, the controller 37 may multiply the steering angle θ1 of the above embodiment by “−1.”

The number of the plurality of steering actuators 41A and 41B is not limited to the embodiment and there may be one or three or more. The plurality of steering actuators 41A and 41B are not limited to hydraulic cylinders and may be hydraulic motors or electric motors.

According to the present invention, the work machine is able to move in the target direction even if the articulate angle has changed.

1. A work machine comprising:
a vehicle body including a rear frame and a front frame coupled to the rear frame so as to turn with respect to the rear frame;
a steering control wheel supported by the front frame;
an actuator configured to change a steering angle of the steering control wheel; and
a controller configured to control the actuator,
the controller being configured to
determine a target direction in which the vehicle body travels,
acquire an articulate angle of the front frame with respect to the rear frame, and
set the steering angle so that the vehicle body moves in the target direction by controlling the actuator in accordance with the articulate angle.

2. The work machine according to claim 1, wherein
the controller is configured to
acquire a current traveling direction of the vehicle body, and
set the steering angle in accordance with the articulate angle so that the current traveling direction matches the target direction.

3. The work machine according to claim 2, wherein
the vehicle body further includes a direction sensor provided to the rear frame, and
the controller is configured to acquire the current traveling direction from the direction sensor.

4. A method for controlling a work machine that includes a vehicle body including a rear frame and a front frame coupled to the rear frame so as to turn with respect to the rear frame, a steering control wheel supported by the front frame, and an actuator configured to change a steering angle of the steering control wheel, the method comprising:
determining a target direction in which the vehicle body travels;
acquiring an articulate angle of the front frame with respect to the rear frame; and
setting the steering angle so that the vehicle body moves in the target direction by controlling the actuator in accordance with the articulate angle.

5. The method according to claim 4, further comprising:
acquiring a current traveling direction of the vehicle body; and
setting the steering angle in accordance with the articulate angle so that the current traveling direction matches the target direction.
